(19) United States
(12) Patent Application Publication
(10) Pub. No.: US 2021/0237515 A1
(43) Pub. Date: Aug. 5, 2021

(54) Tread for an Agricultural Vehicle

(71) Applicant: COMPAGNIE GENERALE DES ETABLISSEMENTS MICHELIN, Clermont-Ferrand (FR)

(72) Inventors: Frédéric PERRIN, Clermont-Ferrand Cedex 9 (FR); David DEAN, Clermont-Ferrand Cedex 9 (FR); Maxime PRAS, Clermont-Ferrand Cedex 9 (FR); Jean-Michel VACHERAND, Clermont-Ferrand Cedex 9 (FR)

(21) Appl. No.: 17/059,375

(22) PCT Filed: May 28, 2019
(86) PCT No.: PCT/FR2019/051248

§ 371 Date: Nov. 27, 2020

(30) Foreign Application Priority Data
May 28, 2018 (FR) 18/54503

(51) Int. Cl. B60C 11/03; B60C 11/11

(52) U.S. Cl. CPC B60C 11/0302; B60C 2200/08; B60C 11/11; B60C 11/0306

(57) ABSTRACT

A tread (2) for a driven axle of an agricultural vehicle, having a tread pattern elements (21) extending radially towards the outside from a bearing surface (22), the tread pattern elements having a total number N of tread pattern blocks (21) that are separated axially from one another, the tread pattern blocks having a contact face (211), a leading face (212) and a trailing face (213), the leading face being inclined at an angle α towards the rear with respect to the radial direction in the rolling direction (15) of the tread, the tread having a number n of tread pattern blocks in the case of which the angle α is between 50 degrees and 75 degrees, the number n being at least equal to 0.2×N.

### FIELD OF THE INVENTION

The present invention relates to a tread intended to equip an agricultural vehicle, and more particularly to a tread having improved traction performance on loose ground.

The invention will be more particularly described with reference to a multipurpose agricultural vehicle, that is to say a vehicle that can be driven both in the fields on loose ground and on roads, such as an agricultural tractor.

A tread for an agricultural vehicle may be for example attached to the periphery of a pneumatic tire, of a solid tire or of a non-pneumatic resilient wheel. Such a tread is intended to run over various types of ground such as the more or less compact soil of the fields, unmade tracks providing access to the fields, and the tarmacked surfaces of roads. Bearing in mind the diversity of use, in the fields and on the road, the tread of an agricultural tractor needs to offer a performance compromise between traction in the field, resistance to chunking, resistance to wear on the road, rolling resistance, and vibrational comfort on the road.

### Definitions

In the present document, a radial direction means any direction that is perpendicular to the axis of rotation of the wheel. This direction corresponds to the direction of the thickness of the tread and is generally referenced “Z”.

A transverse or axial direction means a direction parallel to the axis of rotation of the wheel. This direction is generally referenced “Y”.

A circumferential direction means a direction tangential to any circle centred on the axis of rotation of the wheel. This direction is perpendicular both to the axial direction and to any radial direction. This direction is generally referenced “X”.

Generally, a tire comprises a crown comprising, radially on the outside, a tread that is intended to come into contact with the ground via a tread surface, two beads that are intended to come into contact with a rim on which the tire is mounted, and two sidewalls that join the crown to the beads. A tire for an agricultural tractor comprises a carcass reinforcement, anchored in each bead, usually made up of at least one layer of textile reinforcing elements.

The carcass reinforcement is usually surmounted radially on the outside by a crown reinforcement made up of a plurality of working layers, each working layer being made up of textile or metal reinforcing elements coated in an elastomeric material. The reinforcing elements are generally crossed from one layer to the next.

The tread, which is the part of the tire that is intended to come into contact with the ground when running, comprises a bearing surface parallel or substantially parallel to the crown reinforcement of the tire. Tread pattern elements are moulded integrally on the bearing surface of the tread.

A tread may also not be associated with a tire intended to be mounted on a rigid rim but be associated with a non-pneumatic resilient wheel, that is to say one that is structurally deformable and does not have an enclosed space containing pressurized air.

### PRIOR ART

The treads of agricultural vehicles conventionally have lugs extending from the centre of the tread towards the shoulders. These lugs are disposed on each side of the equatorial mid-plane of the tire so as to form a V-shaped pattern, the tip of the V-shaped pattern (or chevron pattern) being intended to be the first part to enter the contact patch in which contact is made with the ground. The lugs are spaced apart from one another so as to form furrows or grooves; the width of these furrows is determined so as to allow good operation both on the road and on loose ground. The lugs exhibit symmetry with respect to the equatorial mid-plane of the tire, usually with a circumferential offset between the two rows of lugs, similar to that obtained by one half of the tread being rotated about the axis of the tire with respect to the other half of the tread. Moreover, the lugs may be continuous or discontinuous, and may be distributed circumferentially with a spacing that is constant or variable. The lugs have a contact face intended to roll over firm ground, such as for example the roads taken to reach the vicinity of the fields, and a leading face intended to transmit the driving force when the agricultural vehicle is travelling over loose ground, typically the soil in the fields. For this purpose, the leading face of the lugs is generally parallel to a radial direction.

A recurring dissatisfaction relates to the traction performance of the known treads on loose ground. The productivity of agricultural vehicles is directly linked to the traction capability thereof on loose ground. Improving this performance would allow the user to improve not only the efficiency of their equipment but also to reduce their operating costs, for example by reducing the fuel consumption per unit of area covered. Of course, the improvement in traction should not be at the expense of other performance aspects such as for example wear resistance, comfort and the possibility of running at a sufficiently high speed on the road.

### BRIEF DESCRIPTION OF THE INVENTION

This objective has been achieved according to the invention by a tread for a driven axle of an agricultural vehicle, said tread comprising tread pattern elements extending radially towards the outside from a bearing surface, said tread pattern elements comprising a total number N of tread pattern blocks that are separated axially from one another, said tread pattern blocks comprising a contact face, a leading face and a trailing face, said leading face being inclined at an angle α towards the rear with respect to the radial direction in the rolling direction of the tread, said tread comprising a number n of tread pattern blocks in the case of which the angle α is between 50 degrees and 75 degrees, the number n being at least equal to 0.2×N.

Preferably, the angle α is between 60 degrees and 70 degrees.

Also preferably, the number n is at least equal to 0.4×N.

Also preferably, the leading face is made up mainly of two surfaces, a first surface being adjacent to the contact face and a second surface being adjacent to the bearing surface, the inclination angle α being that of the linear regression line of the profile of the leading face, the first surface forming an angle α1 with the radial direction Z, α1 being greater than a and between 50° and 75°, a radial height h of the first surface being at least equal to one third of the height H of the tread pattern block.

Preferably, the tread pattern blocks have a quadrilateral base and form, between one another, rows that are inclined with respect to the transverse direction.

According to a first variant, the tread pattern blocks within each row are disposed such that their leading faces are aligned with one another.

According to a second variant, the tread pattern blocks within each row are disposed such that the leading faces of adjacent blocks are offset with respect to one another in the circumferential direction.

In this second variant, the tread pattern blocks within each row are preferably disposed such that, starting from the most central block of the tread, the front edge corners of the successively adjacent blocks are angularly offset in the circumferential direction and in the opposite direction to the rolling direction by an angular offset of between 45% and 65% of the angular spacing β of the tread pattern.

Preferably, the tread pattern blocks also have transverse sipes.

The invention also relates to a tire and to a non-pneumatic wheel comprising such a tread.

Further features and advantages of the invention will become apparent from the following description given with reference to the appended drawing which shows, by way of non-limiting example, an embodiment of the subject matter of the invention.

### BRIEF DESCRIPTION OF THE FIGURES

FIG. 1 is a perspective view showing a tire comprising a tread according to a first embodiment of the invention;

FIG. 2 is a face-on view of the tire in FIG. 1;

FIG. 3 is a view in section on A-A of the tread of the tire in FIG. 2;

FIG. 4 is a perspective view showing a tire comprising a tread according to a second embodiment of the invention;

FIG. 5 is a face-on view of the tire in FIG. 4;

FIG. 6 is a view in section on B-B of the tread of the tire in FIG. 5;

FIG. 7 is a partial perspective view showing a detail of a tread according to a third embodiment of the invention;

FIGS. 8-a to 8-c are schematic detail views of the profile of a tread pattern block of the tread of the invention;

FIGS. 9 to 11 are schematic views of further examples of profiles of a tread pattern block of the tread of the invention;

FIGS. 12 and 13 are schematic views of further examples of profiles of a tread pattern block of the tread of the invention.

### DESCRIPTION OF THE FIGURES

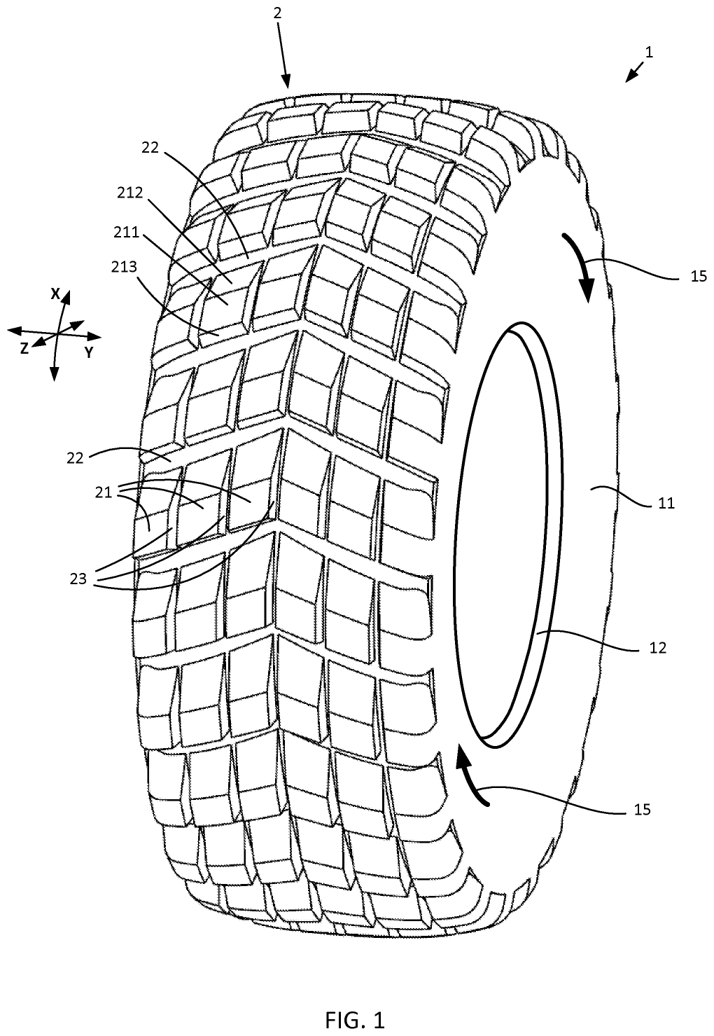

FIG. 1 shows a tire 1 comprising a tread 2 according to the invention. This tire is intended to equip a driven axle of an agricultural vehicle. This tire also comprises sidewalls 11 and beads 12 in a manner known per se. The tread 2 comprises tread pattern blocks 21 that extend radially towards the outside from a bearing surface 22. The blocks are axially separated from one another by cuts 23 that are oriented substantially circumferentially. The preferred direction of rolling of the tire is indicated by arrows 15 moulded on the sidewalls of the tire and/or on the shoulder of the tread.

The tread has a total number “N” of blocks separated from one another. Each block has in particular a contact face 211, a leading face 212 and a trailing face 213. The contact face is the face at the crown of the block that is intended to roll and bear the load on firm ground. On loose ground, the blocks can sink into the ground. In the preferred direction of rolling of the tire, the leading face 212 is thus the face that is the first to enter the contact patch and can transmit a driving force, while the trailing face is the face that is the last to leave the contact patch. The trailing face 213 can only transmit force to the ground during a braking or reversing phase.

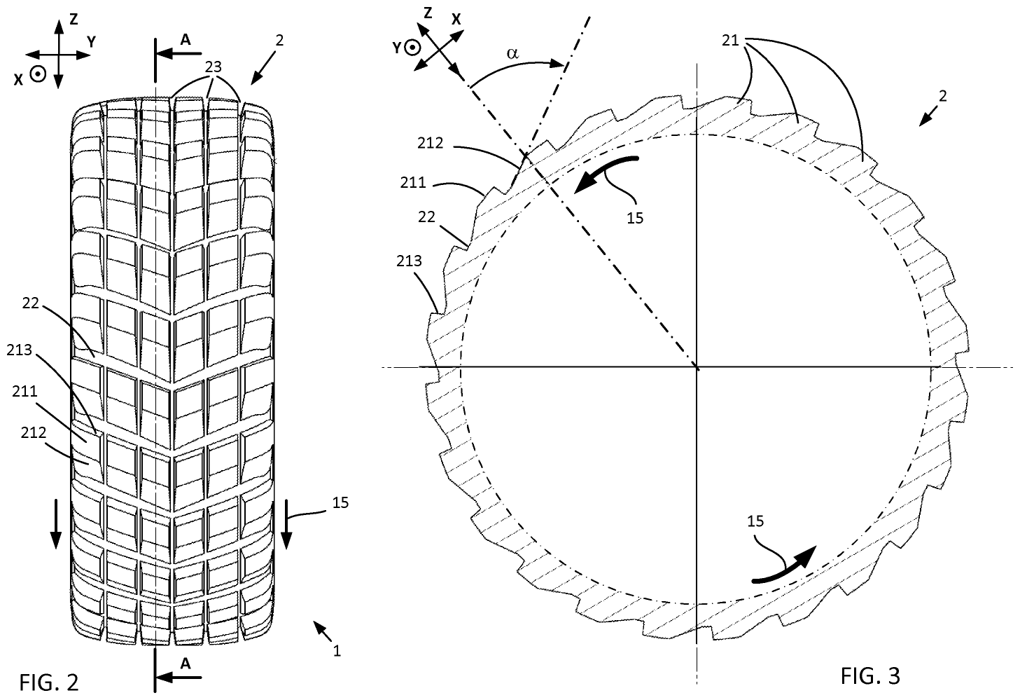

FIG. 3 depicts the section A-A from the face-on view of the tire shown in FIG. 2. This section makes it possible to clearly see the orientation of the leading faces of the blocks. The leading faces are inclined towards the rear with respect to the radial direction in the preferred direction of rolling indicated by the arrows 15 and form an angle α with this radial direction Z. According to the invention, the angle α is between 50° and 75°. In this example, the angle α is 60°.

In this embodiment, all of the blocks of the tread have leading faces inclined at an angle α of between 50° and 75°, meaning that the number n of blocks that comply with this inclination characteristic of their leading face is equal to N. However, the invention can also be implemented when only some of the tread pattern blocks of the tread comply with this inclination characteristic. For example, when the number n of these blocks is at least equal to 0.2×N, that is to say when at least 20% of the blocks comply with this inclination characteristic of their leading face, the benefit in terms of traction on loose ground is already substantial.

In this embodiment, the blocks are disposed across the width of the tread in a six-block pattern. On either side of an equatorial mid-plane of the tire, the blocks are disposed in threes and form, between one another, rows inclined in chevrons with respect to the transverse direction in a manner known per se in the field of treads for agricultural tires. The tread pattern blocks substantially have a quadrilateral base. Within each row, the blocks are disposed such that their leading faces are aligned with one another, meaning that together they are almost continuous, only being interrupted by the cuts 23. The tread shown here is perfectly symmetric with respect to the equatorial mid-plane of the tire. In a variant that is not shown, the patterns of the two halves of the tread that are situated on either side of the equatorial mid-plane can, by contrast, be offset with respect to one another in the circumferential direction, as is often the case for lug tread patterns of prior art agricultural tires.

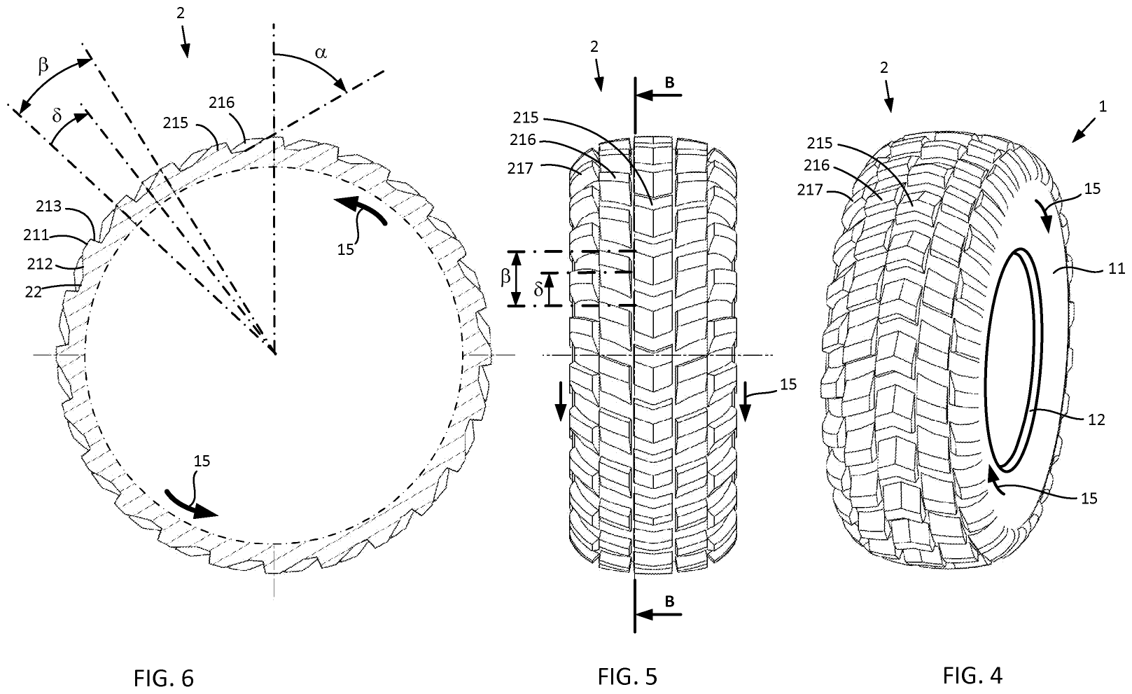

FIGS. 4 to 6 show a second embodiment of a tread according to the invention. The blocks are disposed across the width of the tread in a five-block pattern. The central blocks 215 have a dual leading face, each part of this dual leading face complying with the inclination characteristic set out above. The other blocks are similar to those in the previous embodiment and likewise comply with the inclination described with an angle α close to 60°.

In this second embodiment, the disposition of the blocks differs from that of the first embodiment mainly in that the blocks are no longer aligned within each row but rather are disposed such that the leading faces of adjacent blocks are offset with respect to one another in the circumferential direction. A way of characterizing this offset is more clearly visible in the view in section in FIG. 6. Looking at the angular difference 13 between two successive patterns (β is also referred to as the “angular spacing” of the tread pattern), the intermediate block 216 that is adjacent to a central block 215 and, in the rolling direction of the tire, enters the contact patch after this central block is offset angularly by an angle δ in the opposite direction to the rolling direction (arrows 15). Preferably, this angular offset δ is between 45% and 65% of the angular spacing β. As shown in FIG. 6, the angle δ between two blocks is measured between the front edge corner of the most central block (the edge corner being defined by the intersection of the leading face and the contact face) and the front edge corner of the adjacent block which, in the rolling direction of the tire, enters the contact patch after said central block. The same measurement principle applies for each successively adjacent block and for the two sides of the tread. A similar offset is thus also observed between the intermediate block 216 and the shoulder block 217. Since the tread pattern is in this case symmetric with respect to the equatorial mid-plane of the tire, the same rule applies for the two sides of the tread.

FIG. 7 shows a variant of the first embodiment in FIGS. 1 to 3, in which the blocks also have transverse sipes 218. Similar sipes are of course compatible with other embodiments of the invention.

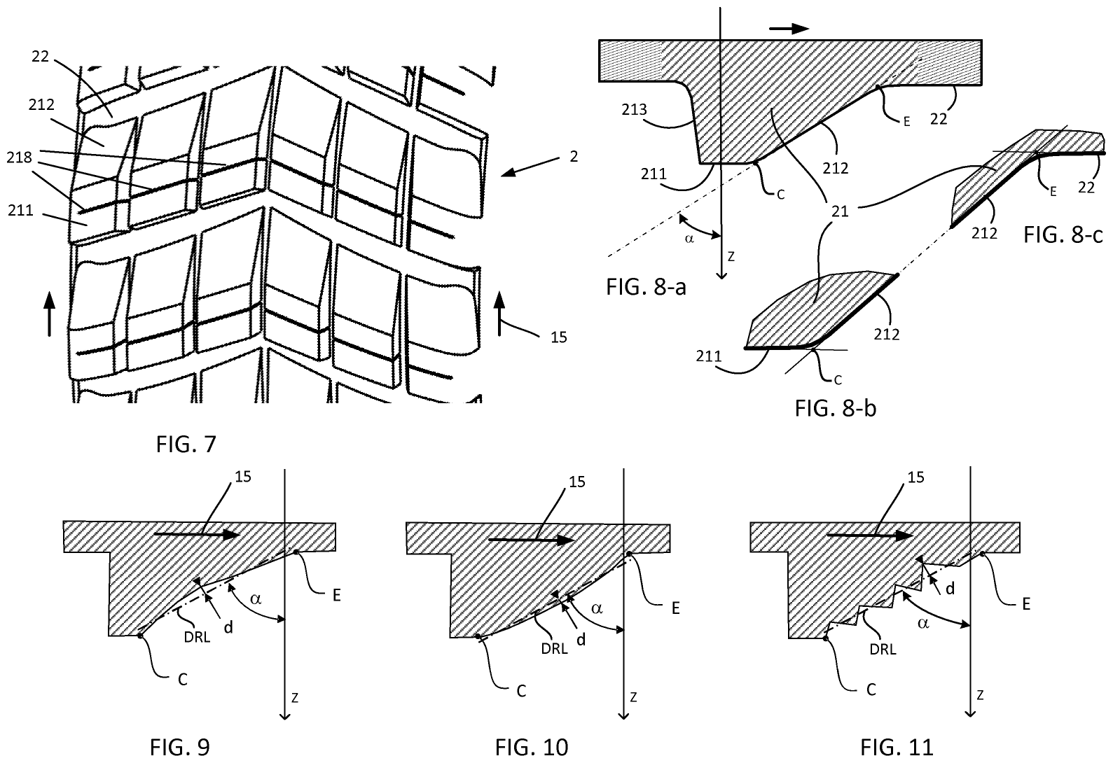

FIGS. 8-a to 8-c show, on a larger scale, an example of a block profile in which the leading face 212 is connected to the contact face 211 and the bearing surface SP by fillets. A point C is defined at the intersection of the continuations of the leading face and of the contact face and a point E is defined at the intersection of the continuations of the leading face 212 and of the bearing surface 22. The inclination angle α of the leading face is thus the angle that the straight line passing through C and E makes with the radial direction Z.

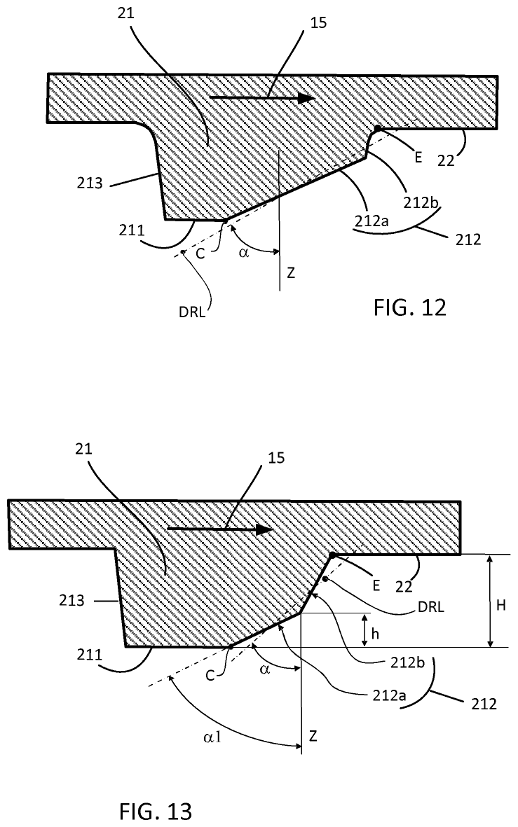

FIGS. 9, 10 and 11 show examples of cases in which the leading face 212 is not flat. In this case, the inclination angle α of the linear regression line DRL of the profile of the leading face between the points C and E at which the leading face meets the contact face 211 and the bearing surface 22, respectively, will be considered. Preferably, the distance d between the profile and the linear regression line DRL thereof remains less than 15 mm.

FIGS. 12 and 13 show cases in which the leading face 212 is made up mainly of two surfaces, a first surface 212a adjacent to the contact face 211 and a second surface 212b adjacent to the bearing surface 22. As explained above for FIGS. 9 to 11, the inclination angle α is that of the linear regression line DRL of the profile of the leading face between the points C and E where the first surface 212a meets the contact face 211 and the second surface 212b meets the bearing surface 22, respectively. The angle α is between 50° and 75°, and preferably between 60° and 70°. The first surface 212a for its part forms an angle α1 with the radial direction Z. This angle α1 is greater than a while also remaining between 50° and 75°. The radial height h of the first surface 212a represents at least one third of the height of the tread pattern block H.

Comparative tests showed that the treads in FIGS. 1 and 4 very substantially enhance the traction performance on loose ground compared with a conventional tread. Improvements of between 10% and 70% were measured depending on the test conditions and in particular depending on the rate of slip considered.

The invention is not intended to be limited to just these described exemplary embodiments and various modifications can be made thereto while remaining within the scope as defined by the claims.

1. A tread for a driven axle of an agricultural vehicle, said tread comprising tread pattern elements extending radially towards the outside from a bearing surface said tread pattern elements comprising a total number N of tread pattern blocks that are separated axially from one another, said tread pattern blocks comprising a contact face, a leading face and a trailing face, said leading face being inclined at an angle α towards the rear with respect to the radial direction in the rolling direction of the tread, said tread comprising a number n of tread pattern blocks in the case of which the angle α is between 50 degrees and 75 degrees, the number n being at least equal to 0.2×N.

2. The tread according to claim 1, wherein the angle α is between 60 degrees and 70 degrees.

3. The tread according to claim 1, wherein the number n is at least equal to 0.4×N.

4. The tread according to claim 1, wherein the leading face is made up mainly of two surfaces, a first surface being adjacent to the contact face and a second surface being adjacent to the bearing surface, the inclination angle α being that of the linear regression line (DRL) of the profile of the leading face, the first surface forming an angle α [symbol] with the radial direction Z, α [symbol] being greater than a and between 50 degrees and 75 degrees, a radial height h of the first surface being at least equal to one third of the height H of the tread pattern block.

5. The tread according to claim 1, wherein the tread pattern blocks have a quadrilateral base and form, between one another, rows that are inclined with respect to the transverse direction Y.

6. The tread according to claim 5, wherein the tread pattern blocks within each row are disposed such that their leading faces are aligned with one another.

7. The tread according to claim 5, wherein the tread pattern blocks within each row are disposed such that the leading faces of adjacent blocks are offset with respect to one another in the circumferential direction X.

8. The tread according to claim 7, wherein the tread pattern blocks within each row are disposed such that, starting from the most central block of the tread, the front edge corners of the successively adjacent blocks are angularly offset in the circumferential direction and in the opposite direction to the rolling direction by an angular offset δ of between 45% and 65% of the angular spacing β of the tread pattern.

9. The tread according to claim 1, wherein the tread pattern blocks also have transverse sipes.

10. A tire comprising a tread according to claim 1.

11. A non-pneumatic wheel comprising a tread according to claim 1.
